(19) United States
(12) Patent Application Publication
(10) Pub. No.: US 2003/0035553 A1
(43) Pub. Date: Feb. 20, 2003

(54) Backwards-compatible perceptual coding of spatial cues

(76) Inventors: Frank Baumgarte, North Plainfield, NJ (US); Jiashu Chen, Basking Ridge, NJ (US); Christof Faller, Murray Hill, NJ (US)

Correspondence Address: MENDELSOHN AND ASSOCIATES PC, 1515 MARKET STREET, SUITE 715, PHILADELPHIA, PA, 19102, US

(21) Appl. No.: 10/045,458

(22) Filed: Nov. 7, 2001

Related U.S. Application Data
(60) Provisional application No. 60/311,565, filed on Aug. 10, 2001.

(51) Int. Cl. H04B 15/00

(52) U.S. Cl. 381/94.2; 381/2

(57) ABSTRACT

Perceptual coding of spatial cues (PCSC) is used to convert two or more input audio signals into a combined audio signal that is embedded with two or more sets of one or more auditory scene parameters, where each set of auditory scene parameters (e.g., one or more spatial cues such as an inter-ear level difference (ILD), inter-ear time difference (ITD), and/or head-related transfer function (HRTF)) corresponds to a different frequency band in the combined audio signal. A PCSC-based receiver is able to extract the auditory scene parameters and apply them to the corresponding frequency bands of the combined audio signal to synthesize an auditory scene. The technique used to embed the auditory scene parameters into the combined signal enables a legacy receiver that is unaware of the embedded auditory scene parameters to play back the combined audio signal in a conventional manner, thereby providing backwards compatibility. In one embodiment, two or more input signals are used to generate a mono audio signal with embedded spatial cues. A PCSC-based receiver can extract and apply the spatial cues to generate two (or more) output audio channels, while a legacy receiver is able to play back the mono audio signal in a conventional (i.e., mono) manner. The backwards compatibility feature can be combined with a layered coding technique and/or a multi-descriptive coding technique to improve error protection when the embedded audio signal is transmitted over one or more lossy channels.

### CROSS-REFERENCE TO RELATED APPLICATIONS

This application claims the benefit of the filing date of U.S. provisional application No. 60/311,565, filed on Aug. 10, 2001 as attorney docket no. Baumgarte 1-6-8, the teachings of which are incorporated herein by reference. The subject matter of this application is related to the subject matter of application Ser. No. 09/848,877, filed on May 4, 2001 as attorney docket no. Faller 5 (“the '877 application”), the teachings of which are incorporated herein by reference.

### BACKGROUND OF THE INVENTION

1. Field of the Invention

The present invention relates to the synthesis of auditory scenes, that is, the generation of audio signals to produce the perception that the audio signals are generated by one or more different audio sources located at different positions relative to the listener.

2. Description of the Related Art

When a person hears an audio signal (i.e., sounds) generated by a particular audio source, the audio signal will typically arrive at the person's left and right ears at two different times and with two different audio (e.g., decibel) levels, where those different times and levels are functions of the differences in the paths through which the audio signal travels to reach the left and right ears, respectively. The person's brain interprets these differences in time and level to give the person the perception that the received audio signal is being generated by an audio source located at a particular position (e.g., direction and distance) relative to the person. An auditory scene is the net effect of a person simultaneously hearing audio signals generated by one or more different audio sources located at one or more different positions relative to the person.

The existence of this processing by the brain can be used to synthesize auditory scenes, where audio signals from one or more different audio sources are purposefully modified to generate left and right audio signals that give the perception that the different audio sources are located at different positions relative to the listener.

FIG. 1 shows a high-level block diagram of conventional binaural signal synthesizer 100, which converts a single audio source signal (e.g., a mono signal) into the left and right audio signals of a binaural signal, where a binaural signal is defined to be the two signals received at the eardrums of a listener. In addition to the audio source signal, synthesizer 100 receives a set of spatial cues corresponding to the desired position of the audio source relative to the listener. In typical implementations, the set of spatial cues comprises an interaural level difference (ILD) value (which identifies the difference in audio level between the left and right audio signals as received at the left and right ears, respectively) and an interaural time delay (ITD) value (which identifies the difference in time of arrival between the left and right audio signals as received at the left and right ears, respectively). In addition or as an alternative, some synthesis techniques involve the modeling of a direction-dependent transfer function for sound from the signal source to the eardrums, also referred to as the head-related transfer function (HRTF). See, e.g., J. Blauert, The Psychophysics of Human Sound Localization, MIT Press, 1983, the teachings of which are incorporated herein by reference.

Using binaural signal synthesizer 100 of FIG. 1, the mono audio signal generated by a single sound source can be processed such that, when listened to over headphones, the sound source is spatially placed by applying an appropriate set of spatial cues (e.g., ILD, ITD, and/or HRTF) to generate the audio signal for each ear. See, e.g., D. R. Begault, 3-D Sound for Virtual Reality and Multimedia, Academic Press, Cambridge, Mass., 1994.

Binaural signal synthesizer 100 of FIG. 1 generates the simplest type of auditory scenes: those having a single audio source positioned relative to the listener. More complex auditory scenes comprising two or more audio sources located at different positions relative to the listener can be generated using an auditory scene synthesizer that is essentially implemented using multiple instances of binaural signal synthesizer, where each binaural signal synthesizer instance generates the binaural signal corresponding to a different audio source. Since each different audio source has a different location relative to the listener, a different set of spatial cues is used to generate the binaural audio signal for each different audio source.

FIG. 2 shows a high-level block diagram of conventional auditory scene synthesizer 200, which converts a plurality of audio source signals (e.g., a plurality of mono signals) into the left and right audio signals of a single combined binaural signal, using a different set of spatial cues for each different audio source. The left audio signals are then combined (e.g., by simple addition) to generate the left audio signal for the resulting auditory scene, and similarly for the right.

One of the applications for auditory scene synthesis is in conferencing. Assume, for example, a desktop conference with multiple participants, each of whom is sitting in front of his or her own personal computer (PC) in a different city. In addition to a PC monitor, each participant's PC is equipped with (1) a microphone that generates a mono audio source signal corresponding to that participant's contribution to the audio portion of the conference and (2) a set of headphones for playing that audio portion. Displayed on each participant's PC monitor is the image of a conference table as viewed from the perspective of a person sitting at one end of the table. Displayed at different locations around the table are real-time video images of the other conference participants.

In a conventional mono conferencing system, a server combines the mono signals from all of the participants into a single combined mono signal that is transmitted back to each participant. In order to make more realistic the perception for each participant that he or she is sitting around an actual conference table in a room with the other participants, the server can implement an auditory scene synthesizer, such as synthesizer 200 of FIG. 2, that applies an appropriate set of spatial cues to the mono audio signal from each different participant and then combines the different left and right audio signals to generate left and right audio signals of a single combined binaural signal for the auditory scene. The left and right audio signals for this combined binaural signal are then transmitted to each participant. One of the problems with such conventional stereo conferencing systems relates to transmission bandwidth, since the server has to transmit a left audio signal and a right audio signal to each conference participant.

### SUMMARY OF THE INVENTION

The '877 application describes a technique for synthesizing auditory scenes that addresses the transmission bandwidth problem of the prior art. According to the '877 application, an auditory scene corresponding to multiple audio sources located at different positions relative to the listener is synthesized from a single combined (e.g., mono) audio signal using two or more different sets of auditory scene parameters (e.g., spatial cues such as an interaural level difference (ILD) value, an interaural time delay (ITD) value, and/or a head-related transfer function (HRTF)). As such, in the case of the PC-based conference described previously, a solution can be implemented in which each participant's PC receives only a single mono audio signal corresponding to a combination of the mono audio source signals from all of the participants (plus the different sets of auditory scene parameters).

The technique described in the '877 application is based on an assumption that, for those frequency bands in which the energy of the source signal from a particular audio source dominates the energies of all other source signals in the mono audio signal, from the perspective of the perception by the listener, the mono audio signal can be treated as if it corresponded solely to that particular audio source. According to implementations of this technique, the different sets of auditory scene parameters (each corresponding to a particular audio source) are applied to different frequency bands in the mono audio signal to synthesize an auditory scene.

The technique described in the '877 application generates an auditory scene from a mono audio signal and two or more different sets of auditory scene parameters. The '877 application describes how the mono audio signal and its corresponding sets of auditory scene parameters are generated. The technique for generating the mono audio signal and its corresponding sets of auditory scene parameters is referred to in this specification as the perceptual coding of spatial cues (PCSC). According to embodiments of the present invention, the PCSC technique is applied to generate a combined (e.g., mono) audio signal in which the different sets of auditory scene parameters are embedded in the combined audio signal in such a way that the resulting PCSC signal can be processed by either a PCSC-based receiver or a conventional (i.e., legacy or non-PCSC) receiver. When processed by a PCSC-based receiver, the PCSC-based receiver extracts the embedded auditory scene parameters and applies the auditory scene synthesis technique of the '877 application to generate a binaural (or higher) signal. The auditory scene parameters are embedded in the PCSC signal in such a way as to be transparent to a conventional receiver, which processes the PCSC signal as if it were a conventional (e.g., mono) audio signal. In this way, the present invention supports the PCSC processing of the '877 application by PCSC-based receivers, while providing backwards compatibility to enable PCSC signals to be processed by conventional receivers in a conventional manner.

In one embodiment, the present invention is a method comprising the steps of (a) converting a plurality of input audio signals into a combined audio signal and a plurality of auditory scene parameters; and (b) embedding the auditory scene parameters into the combined audio signal to generate an embedded audio signal. A first receiver that is aware of the existence of the embedded auditory scene parameters can extract the auditory scene parameters from the embedded audio signal and apply the extracted auditory scene parameters to synthesize an auditory scene, and a second receiver that is unaware of the existence of the embedded auditory scene parameters can process the embedded audio signal to generate an output audio signal, where the embedded auditory scene parameters are transparent to the second receiver.

In another embodiment, the present invention is a method for synthesizing an auditory scene, comprising the steps of (a) receiving an embedded audio signal comprising a combined audio signal embedded with a plurality of auditory scene parameters, wherein a receiver that is unaware of the existence of the embedded auditory scene parameters can process the embedded audio signal to generate an output audio signal, where the embedded auditory scene parameters are transparent to the receiver; (b) extracting the auditory scene parameters from the embedded audio signal; and (c) applying the extracted auditory scene parameters to the combined audio signal to synthesize an auditory scene.

### BRIEF DESCRIPTION OF THE DRAWINGS

Other aspects, features, and advantages of the present invention will become more fully apparent from the following detailed description, the appended claims, and the accompanying drawings in which:

FIG. 1 shows a high-level block diagram of conventional binaural signal synthesizer that converts a single audio source signal (e.g., a mono signal) into the left and right audio signals of a binaural signal;

FIG. 2 shows a high-level block diagram of conventional auditory scene synthesizer that converts a plurality of audio source signals (e.g., a plurality of mono signals) into the left and right audio signals of a single combined binaural signal;

FIG. 3 shows a block diagram of a conferencing system, according to one embodiment of the present invention;

FIG. 4 shows a block diagram of the audio processing implemented by the conference server of FIG. 3, according to one embodiment of the present invention;

FIG. 5 shows a flow diagram of the processing implemented by the auditory scene parameter generator of FIG. 4, according to one embodiment of the present invention;

FIG. 6 shows a graphical representation of the power spectra of the audio signals from three different exemplary sources;

FIG. 7 shows a block diagram of the audio processing performed by each conference node in FIG. 3;

FIG. 8 shows a graphical representation of the power spectrum in the frequency domain for the combined signal generated from the three mono source signals in FIG. 6;

FIG. 9 shows a representation of the analysis window for the time-frequency domain, according to one embodiment of the present invention;

FIG. 10 shows a block diagram of the transmitter for an alternative application of the present invention, according to one embodiment of the present invention;

FIG. 11 shows a block diagram of a conventional digital audio system for mono audio signals;

FIG. 12 shows a block diagram of a PCSC (perceptual coding of spatial cues) digital audio system, according to one embodiment of the present invention;

FIG. 13 shows a block diagram of a digital audio system in which the PCSC transmitter of the PCSC system of FIG. 12 transmits a PCSC signal to the conventional receiver of the conventional system of FIG. 11;

FIG. 14 shows a block diagram of a digital audio system in which the PCSC transmitter applies a layered coding technique, according to one embodiment of the present invention; and

FIG. 15 shows a block diagram of a digital audio system in which the PCSC transmitter applies a multi-descriptive coding technique, according to one embodiment of the present invention.

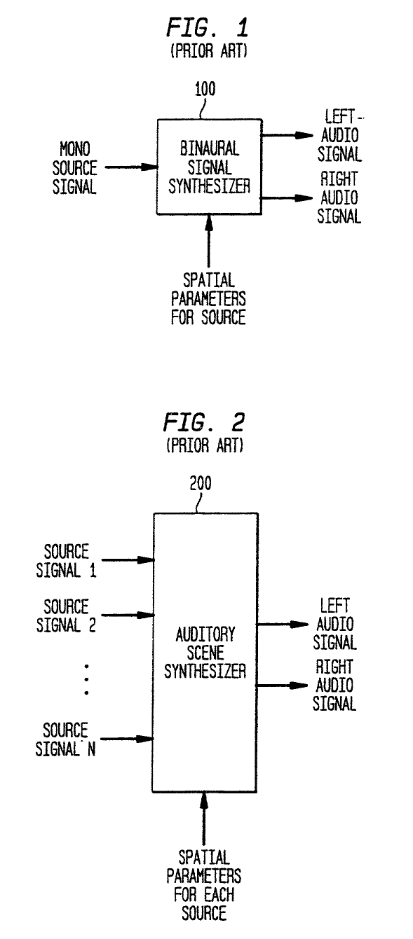

### DETAILED DESCRIPTION

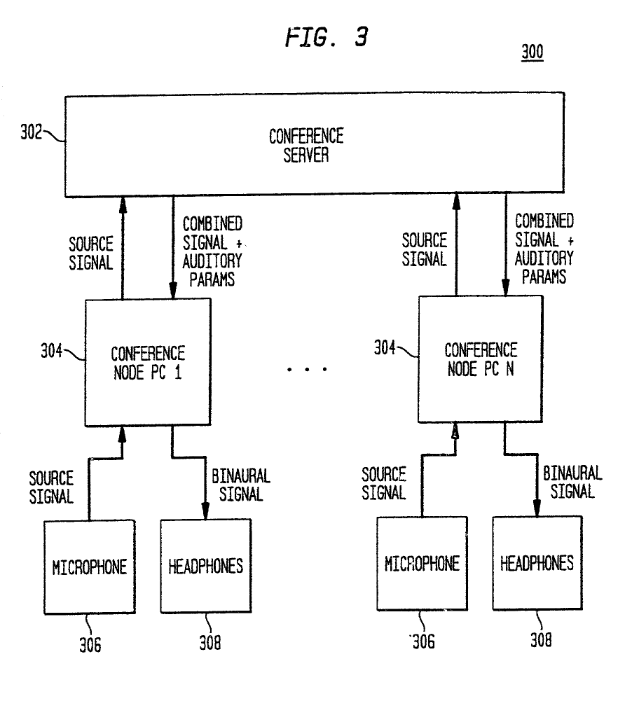

FIG. 3 shows a block diagram of a conferencing system 300, according to one embodiment of the present invention. Conferencing system 300 comprises conference server 302, which supports conferencing between a plurality of conference participants, where each participant uses a different conference node 304. In preferred embodiments of the present invention, each node 304 is a personal computer (PC) equipped with a microphone 306 and headphones 308, although other hardware configurations are also possible. Since the present invention is directed to processing of the audio portion of conferences, the following description omits reference to the processing of the video portion of such conferences, which involves the generation, manipulation, and display of video signals by video cameras, video signal processors, and digital monitors that would be included in conferencing system 300, but are not explicitly represented in FIG. 3. The present invention can also be implemented for audio-only conferencing.

As indicated in FIG. 3, each node 304 transmits a (e.g., mono) audio source signal generated by its microphone 306 to server 302, where that source signal corresponds to the corresponding participant's contribution to the conference. Server 302 combines the source signals from the different participants into a single (e.g., mono) combined audio signal and transmits that combined signal back to each node 304. (Depending on the type of echo-cancellation performed, if any, the combined signal transmitted to each node 304 may be either unique to that node or the same as the combined signal transmitted to every other node. For example, each conference participant may receive a combined audio signal corresponding to the sum of the audio signals from all of the other participants except his own signal.) In addition to the combined signal, server 302 transmits an appropriate set of auditory scene parameters to each node 304. Each node 304 applies the set of auditory scene parameters to the combined signal in a manner according to the present invention to generate a binaural signal for rendering by headphones 308 and corresponding to the auditory scene for the conference.

The processing of conference server 302 may be implemented within a distinct node of conferencing system 300. Alternatively, the server processing may be implemented in one of the conference nodes 304, or even distributed among two or more different conference nodes 304.

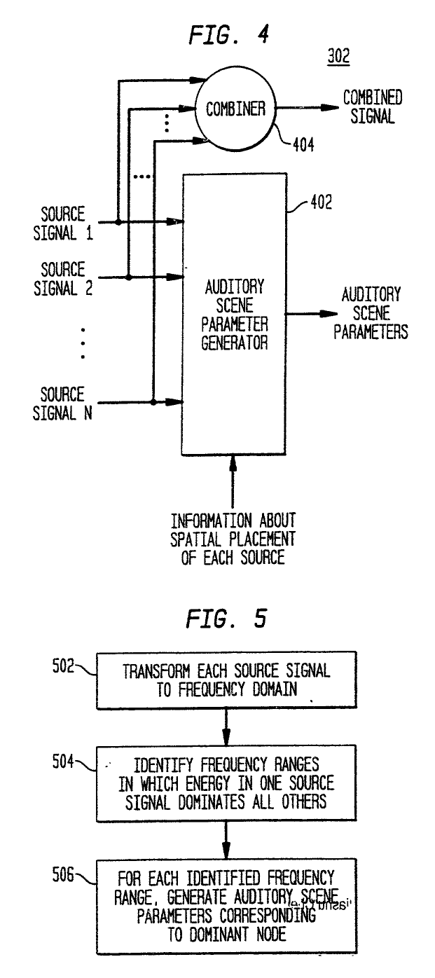

FIG. 4 shows a block diagram of the audio processing implemented by conference server 302 of FIG. 3, according to one embodiment of the present invention. As shown in FIG. 4, auditory scene parameter generator 402 generates one or more sets of auditory scene parameters from the plurality of source signals generated by and received from the various conference nodes 304 of FIG. 3. In addition, signal combiner 404 combines the plurality of source signals (e.g., using straightforward audio signal addition) to generate the combined signal(s) that is transmitted back to each conference node 304.

FIG. 5 shows a flow diagram of the processing implemented by auditory scene parameter generator 402 of FIG. 4, according to one embodiment of the present invention. Generator 402 applies a time-frequency (TF) transform, such as a discrete Fourier transform (DFT), to convert each node's source signal to the frequency domain (step 502 of FIG. 5). Generator 402 then compares the power spectra of the different converted source signals to identify one or more frequency bands in which the energy one of the source signals dominates all of the other signals (step 504).

Depending on the implementation, different criteria may be applied to determine whether a particular source signal dominates the other source signals. For example, a particular source signal may be said to dominate all of the other source signals when the energy of that source signal exceeds the sum of the energies in the other source signals by either a specified factor or a specified amount of power (e.g., in dBs). Alternatively, a particular source signal may be said to dominate when the energy of that source signal exceeds the second most powerful source signal by a specified factor or a specified amount of power. Other criteria are, of course, also possible, including those that combine two or more different comparisons. For example, in addition to relative domination, a source signal might have to have an absolute energy level that exceeds a specified energy level before qualifying as a dominating source signal.

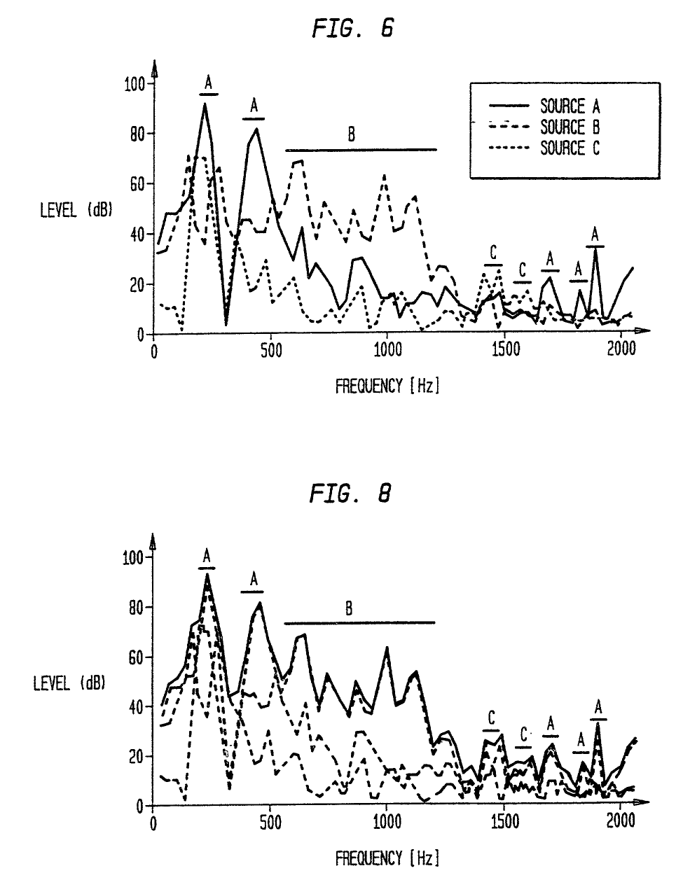

FIG. 6 shows a graphical representation of the power spectra of the audio signals from three different exemplary sources (labeled A, B, and C). FIG. 6 identifies eight different frequency bands in which one of the three source signals dominates the other two. Note that, in FIG. 6, there are particular frequency ranges in which none of the three source signals dominate. Note also that the lengths of the dominated frequency ranges (i.e., frequency ranges in which one of the source signals dominates) are not uniform, but rather are dictated by the characteristics of the power spectra themselves.

Returning to FIG. 5, after generator 402 identifies one or more frequency bands in which one of the source signals dominates, a set of auditory scene parameters is generated for each frequency band, where those parameters correspond to the node whose source signal dominates that frequency band (step 506). In some implementations, the processing of step 506 implemented by generator 402 generates the actual spatial cues (e.g., ILD, ITD, and/or HRTF) for each dominated frequency band. In those cases, generator 402 receives (e.g., a priori) information about the relative spatial placement of each participant in the auditory scene to be synthesized (as indicated in FIG. 4). In addition to the combined signal, at least the following auditory scene parameters are transmitted to each conference node 304 of FIG. 3 for each dominated frequency band:

(1) Frequency of the start of the frequency band;

(2) Frequency of the end of the frequency band; and

(3) One or more spatial cues (e.g., ILD, ITD, and/or HRTF) for the frequency band.

Although the identity of the particular node/participant whose source signal dominates the frequency band can be transmitted, such information is not required for the subsequent synthesis of the auditory scene. Note that, for those frequency bands, for which no source signal is determined to dominate, no auditory scene parameters or other special information needs to be transmitted to the different conference nodes 304.

In other implementations, the generation of the spatial cues for each dominated frequency band is implemented independently at each conference node 304. In those cases, generator 402 does not need any information about the relative spatial placements of the various participants in the synthesized auditory scene. Rather, in addition to the combined signal, only the following auditory scene parameters need to be transmitted to each conference node 304 for each dominated frequency band:

(1) Frequency of the start of the frequency band;

(2) Frequency of the end of the frequency band; and

(3) Identity of the node/participant whose source signal dominates the frequency band.

In such implementations, each conference node 304 is responsible for generating the appropriate spatial cues for each dominated frequency range. Such implementation enables each different conference node to generate a unique auditory scene (e.g., corresponding to different relative placements of the various conference participants within the synthesized auditory scene).

In either type of implementation, the processing of FIG. 5 is preferably repeated at a specified interval (e.g., once for every 20-msec frame of audio data). As a result, the number and definition of the dominated frequency ranges as well as the particular source signals that dominate those ranges will typically vary over time (e.g., from frame to frame), reflecting the fact that the set of conference participants who are speaking at any given time will vary over time as will the characteristics of their own individual voices (e.g., intonations and/or volumes). Depending on the implementation, the spatial cues corresponding to each conference participant may be either static (e.g., for synthesis of stationary participants whose relative positions do not change over time) or dynamic (e.g., for synthesis of mobile participants who relative positions are allowed to change over time).

In alternative embodiments, rather than selecting a set of spatial cues that corresponds to a single source, a set of spatial cues can be generated that reflects the contributions of two or more—or even all—of the participants. For example, weighted averaging can be used to generate an ILD value that represents the relative contributions for the two or more most dominant participants. In such cases, each set of spatial cues is a function of the relative dominance of the most dominant participants for a particular frequency band.

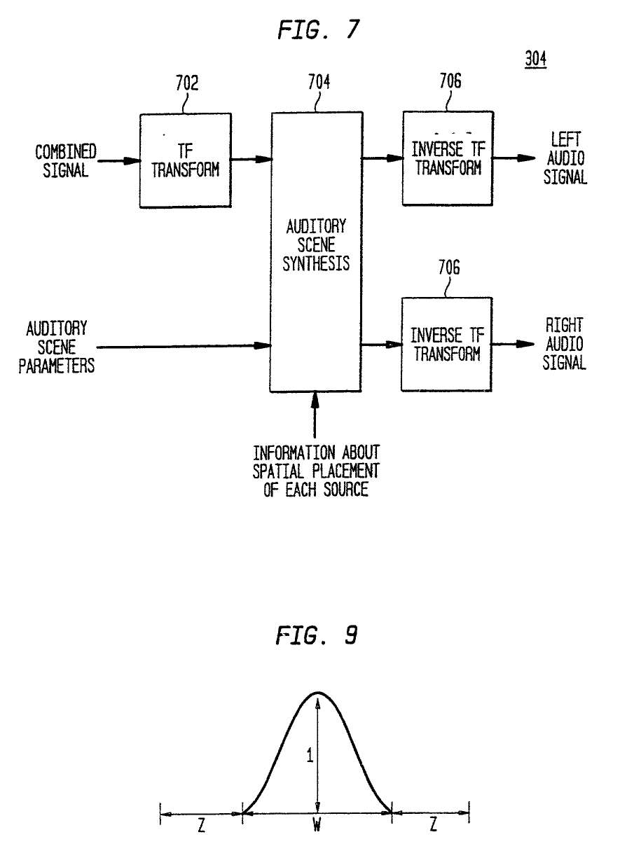

FIG. 7 shows a block diagram of the audio processing performed by each conference node 304 in FIG. 3 to convert a single combined mono audio signal and corresponding auditory scene parameters received from conference server 302 into the binaural signal for a synthesized auditory scene. In particular, time-frequency (TF) transform 702 converts each frame of the combined signal into the frequency domain.

For each dominated frequency band, auditory scene synthesizer 704 applies the corresponding auditory scene parameters to the converted combined signal to generate left and right audio signals for that frequency band in the frequency domain. In particular, for each audio frame and for each dominated frequency band, synthesizer 704 applies the set of spatial cues corresponding to the participant whose source signal dominates the combined signal for that dominated frequency range. If the auditory scene parameters received from the conference server do not include the spatial cues for each conference participant, then synthesizer 704 receives information about the relative spatial placement of the different participants in the synthesized auditory scene as indicated in FIG. 7, so that the set of spatial cues for each dominated frequency band in the combined signal can be generated locally at the conference node.

An inverse TF transform 706 is then applied to each of the left and right audio signals to generate the left and right audio signals of the binaural signal in the time domain corresponding to the synthesized auditory scene. The resulting auditory scene is perceived as being approximately the same as for an ideally synthesized binaural signal with the same corresponding spatial cues but applied over the whole spectrum of each individual source signal.

FIG. 8 shows a graphical representation of the power spectrum in the frequency domain for the combined signal generated from the three mono source signals from sources A, B, and C in FIG. 6. In addition to showing the three different source signals (dotted lines), FIG. 8 also shows the same frequency bands identified in FIG. 6 in which the power of one of the three source signals dominates the other two. It is to these dominated frequency bands to which auditory scene synthesizer 704 applies appropriate sets of spatial cues.

In a typical audio frame, not all of the conference participants will dominate at least one frequency band, since not all of the participants will typically be talking at the same time. If only one participant is talking, then only that participant will typically dominate any of the frequency bands. By the same token, during an audio frame corresponding to relative silence, it may be that none of the participants will dominate any frequency bands. For those frequency bands for which no dominating participant is identified, no spatial cues are applied and the left and right audio signals of the resulting binaural signal for those frequency bands are identical.

Time-Frequency Transform

As indicated above, TF transform 702 in FIG. 7 converts the combined mono audio signal to the spectral (i.e., frequency) domain frame-wise in order for the system to operate for real-time applications. For each frequency band n at each time k (e.g., frame number k), a level difference ΔLₙ[k], a time difference τₙ[k], and/or an HRTF is to be introduced into the underlying audio signal. In a preferred embodiment, TF transform 702 is a DFT-based transform, such as those described in A. V. Oppenheim and R. W. Schaefer, Discrete-Time Signal Processing, Signal Processing Series, Prentice Hall, 1989, the teachings of which are incorporated herein by reference. The transform is derived based on the desire for the ability to synthesize frequency-dependent and time-adaptive time differences τₙ[k]. The same transform can be used advantageously for the synthesis of frequency-dependent and time-adaptive level differences ΔLₙ[k] and for HRTFs.

When W samples s₀, . . . ,s_{W-1} in the time domain are converted to W samples S₀, . . . ,S_{W-1} in a complex spectral domain with a DFT transform, then a circular time-shift of d time-domain samples can be obtained by modifying the W spectral values according to Equation (1) as follows:

$${\hat{S}}_{n} = {S}_{n} {ⅇ}^{- \frac{2 π nd}{W}} . \qquad ( 1 )$$

In order to introduce a non-circular time-shift within each frame (as opposed to a circular time-shift), the time-domain samples s₀, . . . ,s_{W-1} are padded with Z zeros at the beginning and at the end of the frame and a DFT of size N=2Z+W is then used. By modifying the resulting spectral coefficients, a non-circular time-shift within the range dε[−ZZ] can be implemented by modifying the resulting N spectral coefficients according to Equation (2) as follows:

$${\hat{S}}_{n} = {S}_{n} {ⅇ}^{- \frac{2 π nd}{N}} . \qquad ( 2 )$$

The described scheme works as long as the time-shift d does not vary in time. Since the desired d usually varies over time, the transitions are smoothed by using overlapping windows for the analysis transform. A frame of N samples is multiplied with the analysis window before an N-point DFT is applied. The following Equation (3) shows the analysis window, which includes the zero padding at the beginning and at the end of the frame:

$$\begin{matrix}{w}_{a} [ k ] = 0 & \text{for} & k < Z \\ {w}_{a} [ k ] = {sin}^{2} ( \frac{( k - Z ) π}{W} ) & \text{for} & Z \leq k < Z + W \\ {w}_{a} [ k ] = 0 & \text{for} & Z + W \leq k\end{matrix} \qquad ( 3 )$$

where Z is the width of the zero region before and after the window. The non-zero window span is W, and the size of the transform is N=2Z+W.

FIG. 9 shows a representation of the analysis window, which was chosen such that it is additive to one when windows of adjacent frames are overlapped by W/2 samples. The time-span of the window shown in FIG. 9 is shorter than the DFT length such that non-circular time-shifts within the range [−Z,Z] are possible. To gain more flexibility in changing time differences, level differences, and HRTFs in time and frequency, a higher factor of oversampling can be used by choosing the time-span of the window to be smaller and/or by overlapping the windows more.

The zero padding of the analysis window shown in FIG. 9 allows the implementation of convolutions with HRTFs as simple multiplications in the frequency domain. Therefore, the transform is also suitable for the synthesis of HRTFs in addition to time and level differences. A more general and slightly different point of view of a similar transform is given by J. B. Allen, “Short-term spectral analysis, synthesis and modification by discrete fourier transform,” IEEE Trans. on Speech and Signal Processing, vol. ASSP-25, pp.235-238, June 1977, the teachings of which are incorporated herein by reference.

Obtaining a Binaural Signal from a Mono Signal

In certain implementations, auditory scene synthesizer 704 of FIG. 7 applies different sets of specified level and time differences to the different dominated frequency bands in the combined signal to generate the left and right audio signals of the binaural signal for the synthesized auditory scene. In particular, for each frame k, each dominated frequency band n is associated with a level difference ΔLₙ[k] and a time difference τₙ[k]. In preferred embodiments, these level and time differences are applied symmetrically to the spectrum of the combined signal to generate the spectra of the left and right audio signals according to Equations (4) and (5), respectively, as follows:

$$\begin{matrix}{S}_{n}^{L} = \frac{{10}^{\frac{Δ {L}_{n}}{10}}}{\sqrt{1 + {10}^{\frac{2 Δ {L}_{n}}{10}}}} {S}_{n} {ⅇ}^{- \frac{2 π n {τ}_{n}}{2 N}} \\ \text{and} & ( 4 ) \\ {S}_{n}^{R} = \frac{1}{\sqrt{1 + {10}^{\frac{2 Δ {L}_{n}}{10}}}} {S}_{n} {ⅇ}^{\frac{2 π n {τ}_{n}}{2 N}} & ( 5 )\end{matrix}$$

where {Sₙ} are the spectral coefficients of the combined signal and {Sₙ^{L}} and {Sₙ^{R}} are the spectral coefficients of the resulting binaural signal. The level differences {ΔLₙ} are expressed in dB and the time differences {τₙ} in numbers of samples.

For the spectral synthesis of auditory scenes based on HRTFs, the left and right spectra of the binaural signal may be obtained using Equations (6) and (7), respectively, as follows:

$$\begin{matrix}{S}_{n}^{L} = {\sum }_{m = 1}^{M} {w}_{m , n} {H}_{m , n}^{L} {S}_{n} \\ \text{and} & ( 6 ) \\ {S}_{n}^{R} = {\sum }_{m = 1}^{M} {w}_{m , n} {H}_{m , n}^{R} {S}_{n} & ( 7 )\end{matrix}$$

where H_{m,n}^{L} and H_{m,n}^{R} are the complex frequency responses of the HRTFs corresponding to the sound source m. For each spectral coefficient, a weighted sum of the frequency responses of the HRTFs of all sources is applied with weights w_{m,n}. The level differences ΔLₙ, time differences τₙ, and HRTF weights w_{m,n} are preferably smoothed in frequency and time to prevent artifacts.

Alternative Embodiments

In the previous sections, the present invention was described in the context of a desktop conferencing application. The present invention can also be employed for other applications. For example, the present invention can be applied where the input is a binaural signal corresponding to an (actual or synthesized) auditory scene, rather than the input being individual mono source signals as in the previous application. In this latter application, the binaural signal is converted into a single mono signal and auditory scene parameters (e.g., sets of spatial cues). As in the desktop conferencing application, this application of the present invention can be used to reduce the transmission bandwidth requirements for the auditory scene since, instead of having to transmit the individual left and right audio signals for the binaural signal, only a single mono signal plus the relatively small amount of spatial cue information need to be transmitted to a receiver, where the receiver performs processing similar to that shown in FIG. 7.

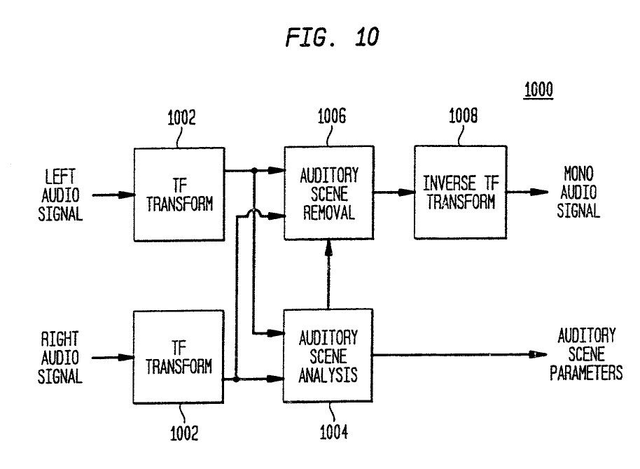

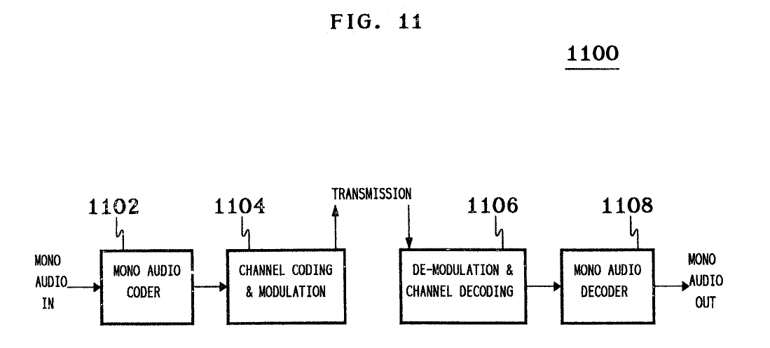

FIG. 10 shows a block diagram of transmitter 1000 for such an application, according to one embodiment of the present invention. As shown in FIG. 10, a TF transform 1002 is applied to corresponding frames of each of the left and right audio signals of the input binaural signal to convert the signals to the frequency domain. Auditory scene analyzer 1004 processes the converted left and right audio signals in the frequency domain to generate a set of auditory scene parameters for each of a plurality of different frequency bands in those converted signals. In particular, for each corresponding pair of audio frames, analyzer 1004 divides the converted left and right audio signals into a plurality of frequency bands. Depending on the implementation, each of the left and right audio signals can be divided into the same number of equally sized frequency bands. Alternatively, the size of the frequency bands may vary with frequency, e.g., larger frequency bands for higher frequencies or smaller frequency bands for higher frequencies.

For each corresponding pair of frequency bands, analyzer 1004 compares the converted left and right audio signals to generate one or more spatial cues (e.g., an ILD value, an ITD value, and/or an HRTF). In particular, for each frequency band, the cross-correlation between the converted left and right audio signals is estimated. The maximum value of the cross-correlation, which indicates how much the two signals are correlated, can be used as a measure for the dominance of one source in the band. If there is 100% correlation between the left and right audio signals, then only one source's energy is dominant in that frequency band. The less the cross-correlation maximum is, the less is just one source dominant. The location in time of the maximum of the cross-correlation can be used to correspond to the ITD. The ILD can be obtained by computing the level difference of the power spectral values of the left and right audio signals. In this way, each set of spatial cues is generated by treating the corresponding frequency range as if it were dominated by a single source signal. For those frequency bands where this assumption is true, the generated set of spatial cues will be fairly accurate. For those frequency bands where this assumption is not true, the generated set of spatial cues will have less perceptual significance to the actual auditory scene. On the other hand, the assumption is that those frequency bands contribute less significantly to the overall perception of the auditory scene. As such, the application of such ”less significant” spatial cues will have little if any adverse affect on the resulting auditory scene. In any case, transmitter 1000 transmits these auditory scene parameters to the receiver for use in reconstructing the auditory scene from the mono audio signal.

Auditory scene remover 1006 combines the converted left and right audio signals in the frequency domain to generate the mono audio signal. In a basic implementation, remover 1006 simply averages the left and right audio signals. In preferred implementations, however, more sophisticated processing is performed to generate the mono signal. In particular, for example, the spatial cues generated by auditory scene analyzer 1004 can be used to modify both the left and right audio signals in the frequency domain as part of the process of generating the mono signal, where each different set of spatial cues is used to modify a corresponding frequency band in each of the left and right audio signals. For example, if the generated spatial cues include an ITD value for each frequency band, then the left and right audio signals in each frequency band can be appropriately time shifted using the corresponding ITD value to make the ITD between the left and right audio signals become zero. The power spectra for the time-shifted left and right audio signals can then be added such that the perceived loudness of each frequency band is the same in the resulting mono signal as in the original binaural signal.

An inverse TF transform 1008 is then applied to the resulting mono audio signal in the frequency domain to generate the mono audio signal in the time domain. The mono audio signal can then be compressed and/or otherwise processed for transmission to the receiver. Since a receiver having a configuration similar to that in FIG. 7 converts the mono audio signal back into the frequency domain, the possibility exists for omitting inverse TF transform 1008 of FIG. 10 and TF transform 702 of FIG. 7, where the transmitter transmits the mono audio signal to the receiver in the frequency domain.

As in the previous application, the receiver applies the received auditory scene parameters to the received mono audio signal to synthesize (or, in this latter case, reconstruct an approximation of) the auditory scene. Note that, in this latter application, there is no need for any a priori knowledge of either the number of sources involved in the original auditory scene or their relative positions. In this latter application, there is no identification of particular sources with particular frequency bands. Rather, the frequency bands are selected in an open-loop manner, but processed with the same underlying assumption as the previous application: that is, that each frequency band can be treated as if it corresponded to a single source using a corresponding set of spatial cues.

Although this latter application has been described in the context of processing in which the input is a binaural signals, this application of the present invention can be extended to (two or multi-channel) stereo signals. Similarly, although the invention has been described in the context of systems that generate binaural signals corresponding to auditory scenes perceived using headphones, the present invention can be extended to apply to the generation of (two or multi-channel) stereo signals for loudspeaker playback.

Backwards-Compatible PCSC Signals

FIG. 11 shows a block diagram of a conventional digital audio system 1100 for mono audio signals. Conventional system 1100 has (a) a conventional transmitter comprising a mono audio (e.g., A-Law/μ-Law) coder 1102 and a channel coding and modulation module 1104 and (b) a conventional receiver comprising a de-modulation and channel decoding module 1106 and a mono audio decoder 1108, where the transmitter transmits a conventional mono audio signal to the receiver. Coder 1102 encodes an input mono audio signal, and module 1104 converts the resulting encoded (e.g., PCM) audio signal for transmission to the receiver. In addition, module 1106 converts the signal received from the transmitter, and decoder 1108 decodes the resulting signal from module 1106 to generate an output mono audio signal.

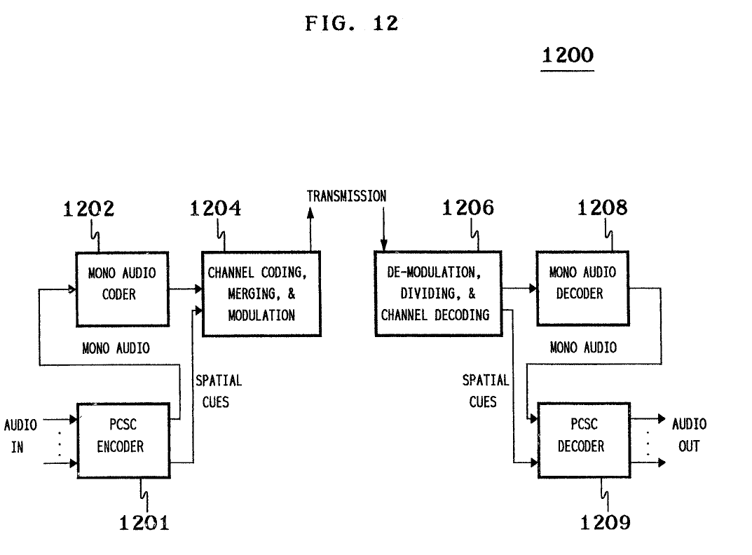

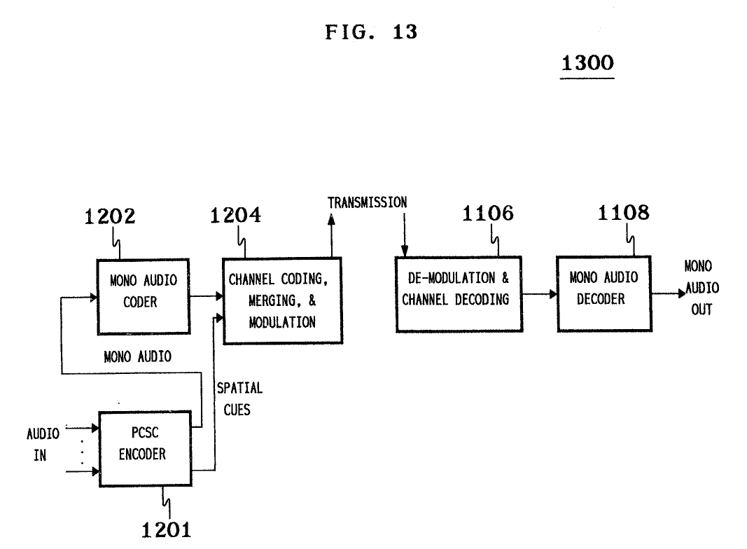

FIG. 12 shows a block diagram of a PCSC (perceptual coding of spatial cues) digital audio system 1200, according to one embodiment of the present invention. PCSC system 1200 has (a) a PCSC transmitter comprising a PCSC encoder 1201, a mono audio coder 1202, and a channel coding, merging, and modulation module 1204 and (b) a PCSC receiver comprising a de-modulation, dividing, and channel decoding module 1206, a mono audio decoder 1208, and a PCSC decoder 1209, where the PCSC transmitter transmits a PCSC signal to the PCSC receiver.

As shown in FIG. 12, PCSC encoder 1201 converts a plurality of input audio signals into a mono audio signal and two or more corresponding sets of auditory scene parameters (e.g., spatial cues). In one application, the plurality of input audio signals is a stereo signal (i.e., a left and a right audio signal), and PCSC encoder 1201 is preferably implemented based on transmitter 1000 of FIG. 10. In another application, the plurality of input audio signals is a plurality of mono audio signals corresponding to different audio sources (e.g., of an audio conference), and PSCS encoder 1201 is preferably implemented based on conference server 302 of FIG. 4. In either case, PCSC encoder 1201 converts the multiple input audio signals into a single mono audio signal and multiple sets of auditory scene parameters. Mono audio coder 1202, which may be identical to conventional mono audio coder 1102 of FIG. 11, encodes the mono audio signal from PCSC encoder 1201 for channel coding, merging, and modulation by module 1204. Module 1204 is preferably similar to conventional module 1104 of FIG. 11, except that module 1204 embeds the sets of auditory scene parameters generated by PCSC encoder 1201 into the mono audio signal received from coder 1202 to generate a PCSC signal that is transmitted to the PCSC receiver.

As described in more detail below, depending on the implementation, in preferred embodiments, module 1204 embeds the sets of auditory scene parameters into the mono audio signal to generate the PCSC signal using any suitable technique that (1) enables a PCSC receiver to extract the embedded sets of auditory scene parameters from the received PCSC signal and apply those auditory scene parameters to the mono audio signal to synthesize an auditory scene using the technique of the '877 application and (2) enables a conventional receiver to process the received PCSC signal to generate a conventional output mono audio signal in a conventional manner (i.e., where the embedded auditory scene parameters are transparent to the conventional receiver).

In particular, de-modulation, dividing, and channel decoding module 1206 extracts the multiple sets of auditory scene parameters from the PCSC signal received from the PCSC transmitter and, using processing similar to that implemented by conventional module 1106 of FIG. 11, recovers an encoded signal. Mono audio decoder 1208, which may be identical to conventional mono audio decoder 1108 of FIG. 11, decodes the signal from module 1206 to generate a decoded mono audio signal. PCSC decoder 1209 applies the multiple sets of auditory scene parameters from module 1206 to the mono audio signal from decoder 1208 using the technique of the '877 application to synthesize an auditory scene. In either the application where the plurality of input audio signals is a stereo signal or the application where the plurality of input audio signals are a plurality of mono audio signals, PCSC encoder 1201 is preferably implemented based on conference node 304 of FIG. 7 to apply the extracted sets of auditory scene parameters to convert the mono audio signal into a binaural signal (for stereo playback) or even more than two audio signals (e.g., for surround sound playback).

FIG. 13 shows a block diagram of a digital audio system 1300 in which the PCSC transmitter of PCSC system 1200 of FIG. 12 transmits a PCSC signal to the conventional receiver of conventional system 1100 of FIG. 11. As indicated in FIG. 13, de-modulation and channel decoding module 1106 and mono audio decoder 1108 apply conventional receiver processing to generate an output mono audio signal from the PCSC signal received from the PCSC transmitter. As indicated above, this processing is enabled by embedding the sets of auditory scene parameters into the transmitted PCSC signal in such a way that the auditory scene parameters are transparent to the conventional receiver. In this way, the PCSC technique of the '877 application can be implemented to achieve backwards compatibility, thereby enabling a PCSC transmitter of the present invention to transmit signals for receipt and processing (albeit different processing) by either a PCSC-based receiver or a conventional receiver. A PCSC-based receiver may be said to be “aware” of the existence of the auditory scene parameters embedded in the PCSC signal, while a conventional receiver may be said to be “unaware” of the existence of those embedded auditory scene parameters.

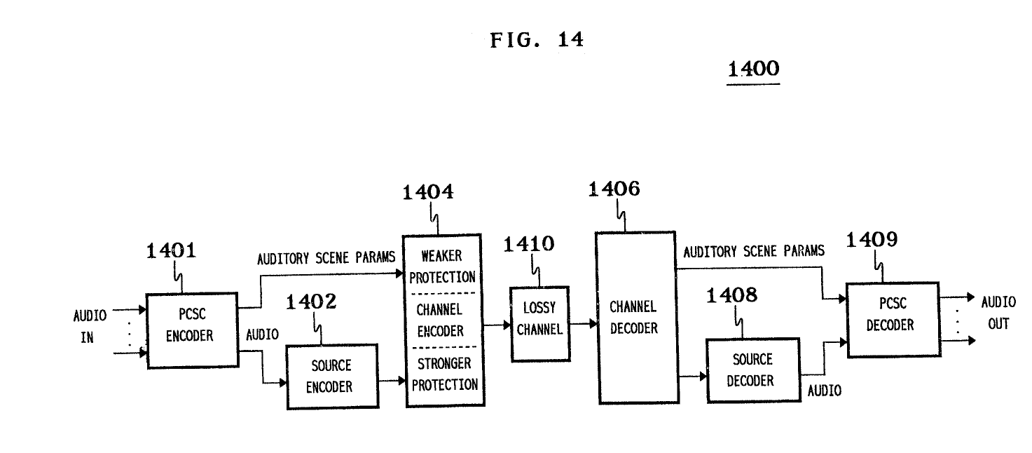

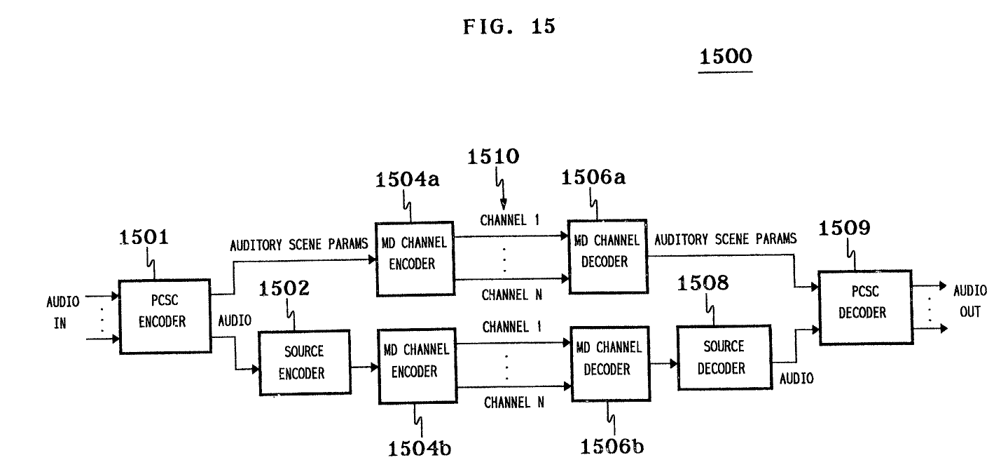

FIG. 14 shows a block diagram of a digital audio system 1400 in which the PCSC transmitter applies a layered coding technique, according to one embodiment of the present invention. In this embodiment, the PCSC transmitter comprises a PCSC encoder 1401, a source encoder 1402, and a channel encoder 1404. Depending on the implementation, PCSC encoder 1401 and source encoder 1402 may be similar to PCSC encoder 1201 and audio coder 1202 of FIG. 12, respectively. Channel encoder 1404 is analogous to module 1204 of FIG. 12, except that channel encoder 1404 applies a layered coding technique in which the combined audio signal from source encoder 1402 gets a stronger error protection than the auditory scene parameters.

The PCSC receiver of system 1400 comprises a channel decoder 1406, a source decoder 1408, and a PCSC decoder 1409. Channel decoder 1406 is analogous to module 1206 of FIG. 12, except that channel decoder 1406 applies a layered decoding technique corresponding to the layered coding technique of channel encoder 1404 to recover as much of the combined audio signal and auditory scene parameters as possible when the embedded audio signal is transmitted over a lossy channel 1410. However much of the combined audio signal is recovered by channel decoder 1406 is processed by source decoder 1408 which is similar to audio decoder 1208 of FIG. 12. The decoded audio signal from source decoder 1408 is then passed to PCSC decoder 1409 which also receives however much of the auditory scene parameters recovered by channel decoder 1406. PCSC decoder 1409 is analogous to PCSC decoder 1209 of FIG. 12, except that PCSC decoder 1409 is able to apply conventional audio processing to just the decoded audio signal from source decoder 1408 in the event that the auditory scene parameters cannot be sufficiently recovered by channel decoder 1406 due to errors resulting from transmission over lossy channel 1410. The use of the layered coding technique provides a more graceful degradation of audio quality at playback for increasing channel error rate by providing a scheme in which the auditory scene parameters will be lost first, thereby optimizing the ability of the receiver at least to play back the audio signal in a conventional (e.g., mono) manner, even if auditory scene synthesis is not possible.

FIG. 15 shows a block diagram of a digital audio system 1500 in which the PCSC transmitter applies a multi-descriptive coding technique, according to one embodiment of the present invention. In this embodiment, the PCSC transmitter comprises a PCSC encoder 1501, a source encoder 1502, and two channel encoders 1404a and 1406b. Depending on the implementation, PCSC encoder 1501 and source encoder 1502 may be similar to PCSC encoder 1201 and audio coder 1202 of FIG. 12, respectively. Channel encoders 1504a and 1504b are analogous to module 1204 of FIG. 12, except that channel encoders 1504a and 1504b each apply a multi-descriptive coding technique in which the corresponding input is divided (e.g., in time and/or frequency) into two or more sub-streams for transmission over two or more different channels 1510, where each corresponding pair of sub-streams carries sufficient information to synthesize an auditory scene, albeit with relatively coarse resolution.

The PCSC receiver of system 1500 comprises two channel decoder 1506a and 1506b, a source decoder 1508, and a PCSC decoder 1509. Channel decoders 1506a and 1506b are analogous to module 1206 of FIG. 12, except that channel decoders 1506a and 1506b each apply a multi-descriptive decoding technique corresponding to the multi-descriptive coding technique of channel encoders 1504a and 1504b to recover as much of the combined audio signal and auditory scene parameters as possible when one or more of channels 1510 are lossy. However much of the combined audio signal is recovered by channel decoder 1506b is processed by source decoder 1508 which is similar to audio decoder 1208 of FIG. 12. The decoded audio signal from source decoder 1508 is then passed to PCSC decoder 1509 which also receives however much of the auditory scene parameters recovered by channel decoder 1506a. PCSC decoder 1509 is analogous to PCSC decoder 1209 of FIG. 12, except that PCSC decoder 1509 is able to synthesize an auditory scene using auditory scene parameters with relatively coarse resolution when one or more of the channels are lossy. The use of the multi-descriptive coding technique provides a more graceful degradation of audio quality at playback for increasing transmission error rate by providing a scheme in which auditory scene parameters having relatively coarse resolution can still be used to synthesize an auditory scene.

Those skilled in the art will understand that the backwards compatibility feature of FIGS. 12-13, the layered coding technique of FIG. 14, and the multi-descriptive coding technique of FIG. 15 can be implemented in any possible combination, including all three features together or just one or two of the features.

Although interfaces between the transmitters and receivers in FIGS. 11-15 have been shown as transmission channels, those skilled in the art will understand that, in addition or in the alternative, those interfaces may include storage mediums. Depending on the particular implementation, the transmission channels may be wired or wire-less and can use customized or standardized protocols (e.g., IP). Media like CD, DVD, digital tape recorders, and solid-state memories can be used for storage. In addition, transmission and/or storage may, but need not, include channel coding. Similarly, although the present invention has been described in FIGS. 12-15 in the context of digital audio systems, those skilled in the art will understand that the present invention can also be implemented in the context of analog audio systems, such as AM radio, FM radio, and the audio portion of analog television broadcasting, each of which supports the inclusion of an additional in-band low-bitrate transmission channel.

The present invention can be implemented for many different applications, such as music reproduction, broadcasting, and telephony. For example, the present invention can be implemented for digital radio/TV/internet (e.g., Webcast) broadcasting such as Sirius Satellite Radio or XM. Other applications include voice over IP, PSTN or other voice networks, analog radio broadcasting, and Internet radio.

Depending on the particular application, different techniques can be employed to embed the sets of auditory scene parameters into the mono audio signal to achieve a PCSC signal of the present invention. The availability of any particular technique may depend, at least in part, on the particular transmission/storage medium(s) used for the PCSC signal. For example, the protocols for digital radio broadcasting usually support inclusion of additional “enhancement” bits (e.g., in the header portion of data packets) that are ignored by conventional receivers. These additional bits can be used to represent the sets of auditory scene parameters to provide a PCSC signal. In general, the present invention can be implemented using any suitable technique for watermarking of audio signals in which data corresponding to the sets of auditory scene parameters are embedded into the audio signal to form a PCSC signal. For example, these techniques can involve data hiding under perceptual masking curves or data hiding in pseudo-random noise. The pseudo-random noise can be perceived as “comfort noise.” Data embedding can also be implemented using methods similar to “bit robbing” used in TDM (time division multiplexing) transmission for in-band signaling. Another possible technique is mu-law LSB bit flipping, where the least significant bits are used to transmit data.

Although the present invention has been described in the context of transmission/storage of a mono audio signal with embedded auditory scene parameters, the present invention can also be implemented for other numbers of channels. For example, the present invention may be used to transmit a two-channel audio signal with embedded auditory scene parameters, which audio signal can be played back with a conventional two-channel stereo receiver. In this case, a PCSC receiver can extract and use the auditory scene parameters to synthesize a surround sound (e.g., based on the 5.1 format). In general, the present invention can be used to generate M audio channels from N audio channels with embedded auditory scene parameters, where M>N.

Although the present invention has been described in the context of receivers that apply the technique of the '877 application to synthesize auditory scenes, the present invention can also be implemented in the context of receivers that apply other techniques for synthesizing auditory scenes that do not necessarily rely on the technique of the '877 application.

The present invention may be implemented as circuit-based processes, including possible implementation on a single integrated circuit. As would be apparent to one skilled in the art, various functions of circuit elements may also be implemented as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A method comprising the steps of:
(a) converting a plurality of input audio signals into a combined audio signal and a plurality of auditory scene parameters; and
(b) embedding the auditory scene parameters into the combined audio signal to generate an embedded audio signal, such that:
a first receiver that is aware of the existence of the embedded auditory scene parameters can extract the auditory scene parameters from the embedded audio signal and apply the extracted auditory scene parameters to synthesize an auditory scene; and
a second receiver that is unaware of the existence of the embedded auditory scene parameters can process the embedded audio signal to generate an output audio signal, where the embedded auditory scene parameters are transparent to the second receiver.

2. The invention of claim 1, wherein the plurality of auditory scene parameters comprise two or more different sets of one or more auditory scene parameters, wherein each set of auditory scene parameters corresponds to a different frequency band in the combined audio signal such that the first receiver synthesizes the auditory scene by (a) dividing an input audio signal into a plurality of different frequency bands; and (b) applying the two or more different sets of one or more auditory scene parameters to two or more of the different frequency bands in the input audio signal to generate two or more synthesized audio signals of the auditory scene, wherein for each of the two or more different frequency bands, the corresponding set of one or more auditory scene parameters is applied to the input audio signal as if the input audio signal corresponded to a single audio source in the auditory scene.

3. The invention of claim 2, wherein each set of one or more auditory scene parameters corresponds to a different audio source in the auditory scene.

4. The invention of claim 2, wherein, for at least one of the sets of one or more auditory scene parameters, at least one of the auditory scene parameters corresponds to a combination of two or more different audio sources in the auditory scene that takes into account relative dominance of the two or more different audio sources in the auditory scene.

5. The invention of claim 2, wherein the two or more synthesized audio signals comprise left and right audio signals of a binaural signal corresponding to the auditory scene.

6. The invention of claim 2, wherein the two or more synthesized audio signal comprise three or more signals of a multi-channel audio signal corresponding to the auditory scene.

7. The invention of claim 1, wherein the combined audio signal corresponds to a combination of two or more different mono source signals, wherein the two or more different frequency bands are selected by comparing magnitudes of the two or more different mono source signals, wherein, for each of the two or more different frequency bands, one of the mono source signals dominates the one or more other mono source signals.

8. The invention of claim 1, wherein the combined audio signal corresponds to a combination of left and right audio signals of a binaural signal, wherein each different set of one or more auditory scene parameters is generated by comparing the left and right audio signals in a corresponding frequency band.

9. The invention of claim 1, wherein the auditory scene parameters comprise one or more of an interaural level difference, an interaural time delay, and a head-related transfer function.

10. The invention of claim 1, wherein step (b) comprises the step of applying a layered coding technique in which stronger error protection is provided to the combined audio signal than to the auditory scene parameters when generating the embedded audio signal, such that errors due to transmission over a lossy channel will tend to affect the auditory scene parameters before affecting the combined audio signal to improve the probability of the first receiver to process at least the combined audio signal.

11. The invention of claim 1, wherein step (b) comprises the step of applying a multi-descriptive coding technique in which the auditory scene parameters and the combined audio signal are both divided into two or more streams, wherein each stream divided from the auditory scene parameters is embedded into a corresponding stream divided from the combined audio signal to form a stream of the embedded audio signal, such that the two or more streams of the embedded audio signal may be transmitted over two or more different channels to the first receiver, such that the first receiver is able to synthesize the auditory scene using extracted auditory scene parameters having relatively coarse resolution when errors result from transmission of one or more of the streams of the embedded audio signal over one or more lossy channels.

12. A machine-readable medium, having encoded thereon program code, wherein, when the program code is executed by a machine, the machine implements a method, comprising the steps of:
(a) converting a plurality of input audio signals into a combined audio signal and a plurality of auditory scene parameters; and
(b) embedding the auditory scene parameters into the combined audio signal to generate an embedded audio signal, such that:
a first receiver that is aware of the existence of the embedded auditory scene parameters can extract the auditory scene parameters from the embedded audio signal and apply the extracted auditory scene parameters to synthesize an auditory scene; and
a second receiver that is unaware of the existence of the embedded auditory scene parameters can process the embedded audio signal to generate an output audio signal, where the embedded auditory scene parameters are transparent to the second receiver.

13. An apparatus comprising:
(a) an encoder configured to convert a plurality of input audio signals into a combined audio signal and a plurality of auditory scene parameters; and
(b) a merging module configure to embed the auditory scene parameters into the combined audio signal to generate an embedded audio signal, such that:
a first receiver that is aware of the existence of the embedded auditory scene parameters can extract the auditory scene parameters from the embedded audio signal and apply the extracted auditory scene parameters to synthesize an auditory scene; and
a second receiver that is unaware of the existence of the embedded auditory scene parameters can process the embedded audio signal to generate an output audio signal, where the embedded auditory scene parameters are transparent to the second receiver.

14. A method for synthesizing an auditory scene, comprising the steps of:
(a) receiving an embedded audio signal comprising a combined audio signal embedded with a plurality of auditory scene parameters, wherein a receiver that is unaware of the existence of the embedded auditory scene parameters can process the embedded audio signal to generate an output audio signal, where the embedded auditory scene parameters are transparent to the receiver;
(b) extracting the auditory scene parameters from the embedded audio signal; and
(c) applying the extracted auditory scene parameters to the combined audio signal to synthesize an auditory scene.

15. The invention of claim 14, wherein the plurality of auditory scene parameters comprise two or more different sets of one or more auditory scene parameters, wherein each set of auditory scene parameters corresponds to a different frequency band in the combined audio signal such that the auditory scene is synthesized by (1) dividing the combined audio signal into a plurality of different frequency bands; and (2) applying the two or more different sets of one or more auditory scene parameters to two or more of the different frequency bands in the combined audio signal to generate two or more synthesized audio signals of the auditory scene, wherein for each of the two or more different frequency bands, the corresponding set of one or more auditory scene parameters is applied to the combined audio signal as if the combined audio signal corresponded to a single audio source in the auditory scene.

16. The invention of claim 15, wherein each set of one or more auditory scene parameters corresponds to a different audio source in the auditory scene.

17. The invention of claim 15, wherein, for at least one of the sets of one or more auditory scene parameters, at least one of the auditory scene parameters corresponds to a combination of two or more different audio sources in the auditory scene that takes into account relative dominance of the two or more different audio sources in the auditory scene.

18. The invention of claim 15, wherein the two or more synthesized audio signals comprise left and right audio signals of a binaural signal corresponding to the auditory scene.

19. The invention of claim 15, wherein the two or more synthesized audio signal comprise three or more signals of a multi-channel audio signal corresponding to the auditory scene.

20. The invention of claim 14, wherein the combined audio signal corresponds to a combination of two or more different mono source signals, wherein the two or more different frequency bands are selected by comparing magnitudes of the two or more different mono source signals, wherein, for each of the two or more different frequency bands, one of the mono source signals dominates the one or more other mono source signals.

21. The invention of claim 14, wherein the combined audio signal corresponds to a combination of left and right audio signals of a binaural signal, wherein each different set of one or more auditory scene parameters is generated by comparing the left and right audio signals in a corresponding frequency band.

22. The invention of claim 14, wherein the auditory scene parameters comprise one or more of an interaural level difference, an interaural time delay, and a head-related transfer function.

23. The invention of claim 14, wherein the embedded audio signal was generated by applying a layered coding technique in which stronger error protection was provided to the combined audio signal than to the auditory scene parameters, such that errors due to transmission over a lossy channel will tend to affect the auditory scene parameters before affecting the combined audio signal to improve the probability of a receiver to process at least the combined audio signal.

24. The invention of claim 14, wherein the embedded audio signal was generated by applying a multi-descriptive coding technique in which the auditory scene parameters and the combined audio signal were both divided into two or more streams, wherein each stream divided from the auditory scene parameters was embedded into a corresponding stream divided from the combined audio signal to form a stream of the embedded audio signal, such that the two or more streams of the embedded audio signal may be transmitted over two or more different channels to a receiver, such that the receiver is able to synthesize the auditory scene using extracted auditory scene parameters having relatively coarse resolution when errors result from transmission of one or more of the streams of the embedded audio signal over one or more lossy channels.

25. A machine-readable medium, having encoded thereon program code, wherein, when the program code is executed by a machine, the machine implements a method for synthesizing an auditory scene, comprising the steps of:
(a) receiving an embedded audio signal comprising a combined audio signal embedded with a plurality of auditory scene parameters, wherein a receiver that is unaware of the existence of the embedded auditory scene parameters can process the embedded audio signal to generate an output audio signal, where the embedded auditory scene parameters are transparent to the receiver;
(b) extracting the auditory scene parameters from the embedded audio signal; and
(c) applying the extracted auditory scene parameters to the combined audio signal to synthesize an auditory scene.

26. An apparatus for synthesizing an auditory scene, comprising:
(a) a dividing module configured to (1) receive an embedded audio signal comprising a combined audio signal embedded with a plurality of auditory scene parameters, wherein a receiver that is unaware of the existence of the embedded auditory scene parameters can process the embedded audio signal to generate an output audio signal, where the embedded auditory scene parameters are transparent to the receiver and (2) extract the auditory scene parameters from the embedded audio signal; and
(b) a decoder configure to apply the extracted auditory scene parameters to the combined audio signal to synthesize an auditory scene.
